(19) United States
(12) Patent Application Publication
(10) Pub. No.: US 2019/0254332 A1
(43) Pub. Date: Aug. 22, 2019

(54) Method of Providing a Restaurant Quality Meal to a Home Cook

(71) Applicant: Cook de Cuisine LLC, Alexandria, VA (US)

(72) Inventor: Matthew J. McCormack, Alexandria, VA (US)

(21) Appl. No.: 15/898,702

(22) Filed: Feb. 19, 2018

(51) Int. Cl. A23L 35/00; G06Q 30/06; G09B 19/00; H04L 12/58

(52) U.S. Cl. CPC A23L 35/00; G06Q 30/0603; H04L 51/32; G09B 19/0092; G06Q 30/0643

(57) ABSTRACT

A method of providing restaurant-quality meals for a home cook is disclosed. The meal kit process aids the home cook by shortening meal preparation time and improves the home cook's technical cooking skills with its detailed instructions and extensive background information. This method comprises the steps of a professional chef offering extensive cultural, historical, culinary, and technical information regarding a meal. The home cook orders a meal kit online, whereupon a professional cook acquires the necessary ingredients, prepares the meal ingredients in a restaurant-quality facility, packages the individual sections into a meal kit, and delivers the meal kit to the home cook's residence. The home cook completes the meal by cooking the protein and the side dish(s) and/or assembling a salad.

### CROSS-REFERENCE TO RELATED APPLICATIONS

This application claims the benefit of U.S. Provisional Patent Application No. 62/461,163, filed on Feb. 20, 2017, pending, the disclosure of which application is incorporated by reference as if fully set forth therein.

### STATEMENT THAT SUBSTITUTE SPECIFICATION CONTAINS NO NEW MATTER

This substitute specification contains no new matter in regards to the specification filed in application Ser. No. 15/898,702 with a filing or 371(c) date of Feb. 19, 2018.

### BACKGROUND OF THE INVENTION

The time demands of modern family life are extensive. With multiple work schedules, long commutes, and children's school and afterschool activities, most adults don't have the time to prepare a healthy, flavorful, and well-constructed meal at home. This aspect is especially true during the workweek. When these adults do find the time to prepare a meal, the meals are repetitive and the culinary objectives are minimal. As a result, the quality of the meal and the satisfaction of the diner are low.

To remedy this scenario, families eat at restaurants, consume prepared frozen meals, or order prepared meal kits. These remedies cause the home cook's technical skills to decline since he or she cooks less often. In particular, prior art meal kits do not account for consumer skill atrophy. Prior art is characterized by WO91/18792 to Shi and U.S. Publication No. 2009/0181131 to Forbes-Roberts.

### SUMMARY OF THE INVENTION

A need exists for a food service that can provide restaurant quality meals to a home cook, lower costly food waste from lack of planning, lessen the time needed for shopping, and reduce the preparation time needed to construct a meal. Furthermore, the home cook will be educated in the culinary arts and provided with guidance to enable them to successfully recreate a restaurant-quality meal.

A professional cook publishes a menu along with detailed information about each menu item. A home cook reviews and orders a meal kit for delivery at a future time. A professional cook purchases and prepares the meal ingredients in a restaurant or industrial kitchen. The professional prepares the ingredients just as a fine dining restaurant prior to the meal serve, and packages the prepped ingredients for short-term storage and transport. Upon home delivery, the home cook reviews the cultural and technical information about the dish and ingredients as well as reads the detailed, step-by-step instructions on the meal. The home cook completes the meal preparation and final assembly for consumption. This process enables a home cook to more quickly assemble and prepare a quality, home cooked meal while simultaneously improve their cooking skills.

### BRIEF DESCRIPTION OF THE DRAWINGS

FIG. 1 illustrates the research step.

FIG. 2 illustrates the recipe creation step.

FIG. 3 illustrates the menu-testing step.

FIG. 4 illustrates the marketing step.

FIG. 5 illustrates the purchasing step.

FIG. 6 illustrates the recipe transmission step.

FIG. 7 illustrates the meal preparation and delivery step.

FIG. 8 illustrates the meal completion step.

FIGS. 9A and 9B show an example of a meal description providing educational, cultural, and historical information.

FIGS. 10A and 10B show an example of a meal recipe.

### DETAILED DESCRIPTION OF CERTAIN ILLUSTRATED EMBODIMENTS

This specification illustrates an multiple-step process for a food service that can provide restaurant quality meals to a home cook, lower costly food waste from lack of planning, lessen the time needed for shopping, and reduce the preparation time needed to construct a meal. Furthermore, the home cook is educated in the culinary arts and provided with guidance to enable them to successfully recreate a restaurant-quality meal. For the purpose of this specification, the professional chef works as an employee of a business entity that provides meal kits, catering services, or other food services. The professional chef can be one person or multiple persons. The home cook and consumer can also be one person or multiple persons.

### Steps 1 and 2: Research and Recipe Creation

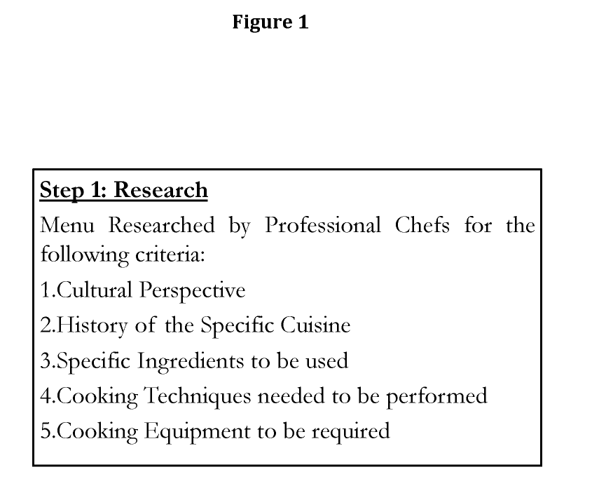

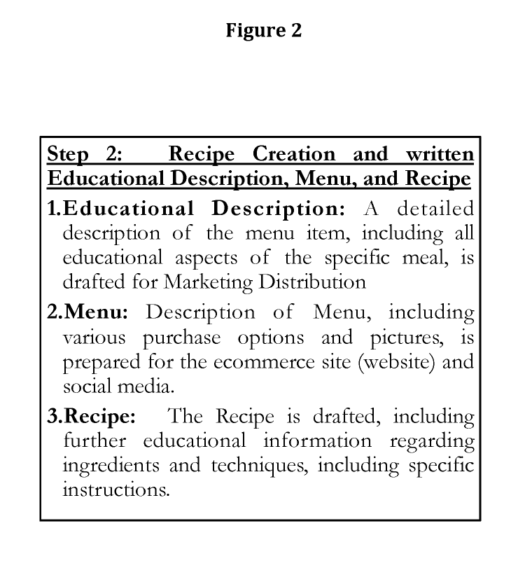

As seen in FIG. 1, a menu is researched by a professional chef for the following criteria: cultural perspective, history of the specific cuisine, uniqueness of ingredients, advanced cooking techniques and specialized cooking equipment. Once the menu research is completed, the chef creates a written educational description, menu, and recipe, as listed in FIG. 2. A detailed description of the menu item, including all educational aspects of the specific meal, is drafted for marketing distribution. The menu description, including various purchase options and pictures, is prepared for the company's ecommerce site, website, social media outlet(s) or any other known marketing platform. The recipe is drafted, including further educational information regarding ingredients, techniques, and specific instructions.

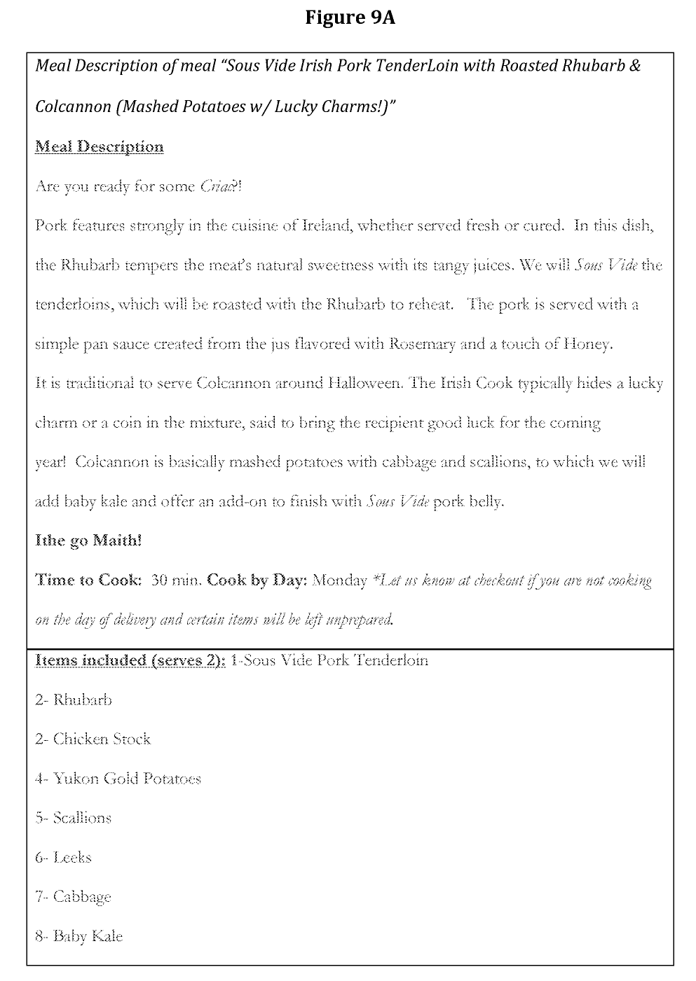

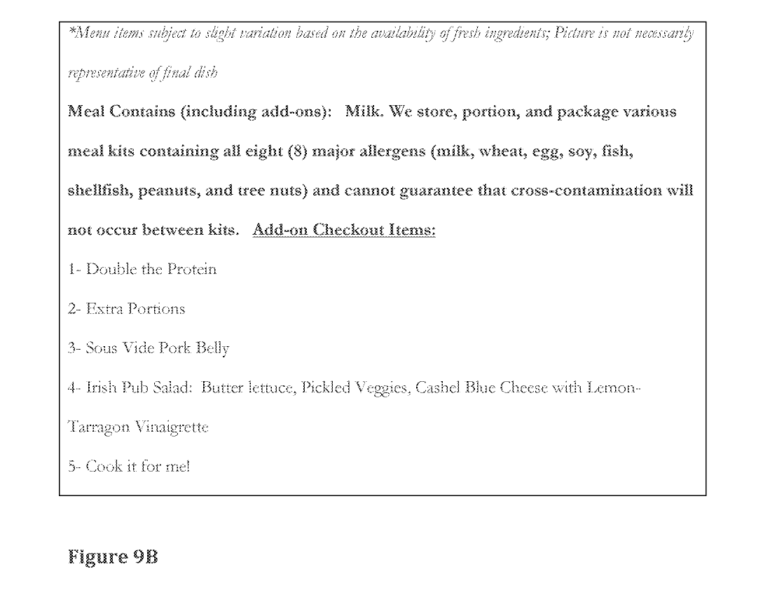

FIGS. 9A and 9B detail a sample educational meal description and menu. When the meal service offers Irish Pork Tenderloin with Roasted Rhubarb and Colcannon, the chef educates the home cook by describing it in the following manner:

Pork features strongly in the cuisine of Ireland, whether served fresh or cured. In this dish, the Rhubarb tempers the meat's natural sweetness with its tangy juices. We will Sous Vide the tenderloins, which will be roasted with the Rhubarb to reheat. The pork is served with a simple pan sauce created from the jus flavored with Rosemary and a touch of Honey.

It is traditional to serve Colcannon around Halloween. The Irish Cook typically hides a lucky charm or a coin in the mixture, said to bring the recipient good luck for the coming year! Colcannon is basically mashed potatoes with cabbage and scallions, to which we will add baby kale and offer an add-on to finish with Sous Vide pork belly.

### Step 3: Menu Testing

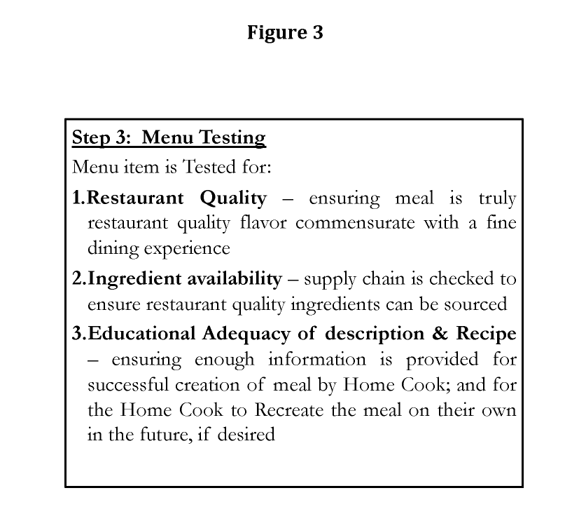

Upon completion of the research and recipe creation, the professional chef tests the menu as seen in FIG. 3. First, the chef verifies that the meal is truly restaurant quality in flavor, commensurate with a fine dining experience. Second, the chef checks the supply chain to ensure restaurant quality ingredients can be sourced. Third, the chef reviews the educational adequacy of the description and recipe to check that enough information is provided for successful meal creation by the home cook and, if desired, for the home cook to recreate on their own in the future.

### Step 4: Marketing

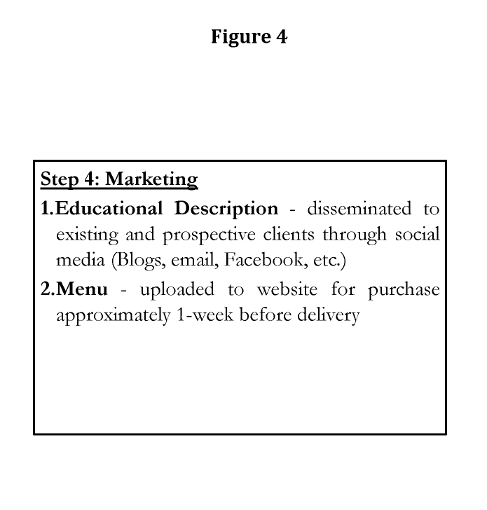

Once the menu testing is complete, the cook uses various methods to communicate the current menu offerings. In FIG. 4, the educational description is disseminated to prospective and existing clients through electronic platforms such as email, blogs, and social media (Facebook, Twitter, etc.). The menu is uploaded to the company's website for ordering and purchasing approximately one week before delivery.

### Step 5: Home Cook Purchase

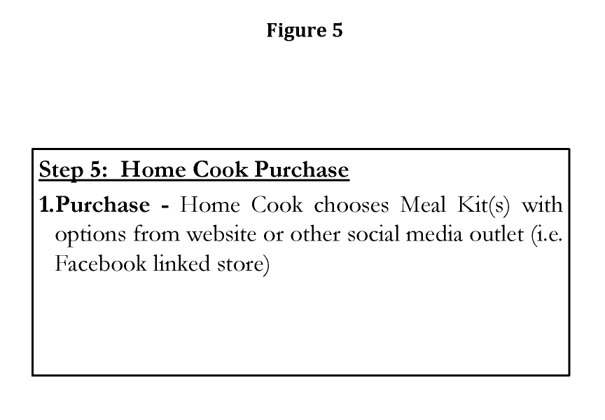

In FIG. 5, the home cook chooses the meal kit(s) with options from the company website or other social media outlets such as Facebook linked store. Meals can be ordered a la carte or as part of a subscription service. Each kit is customizable to add additional items, such as extra protein, kid's meals, salads, and desserts, among others. Customers order and pay through a website. Known Internet methods are used to publish the menu as well as select, transact, and validate orders.

Note in FIG. 9B, an alternate embodiment of this invention consists of an option called Cook It For Me! This option allows the home cook to request that meal be cooked and completed prior to delivery. For an additional fee, the home cook requests that the professional chef perform the final meal assembly and the meal delivered to the home cook essentially completed.

### Step 6: Recipe Sent to Home Cook Prior to Delivery

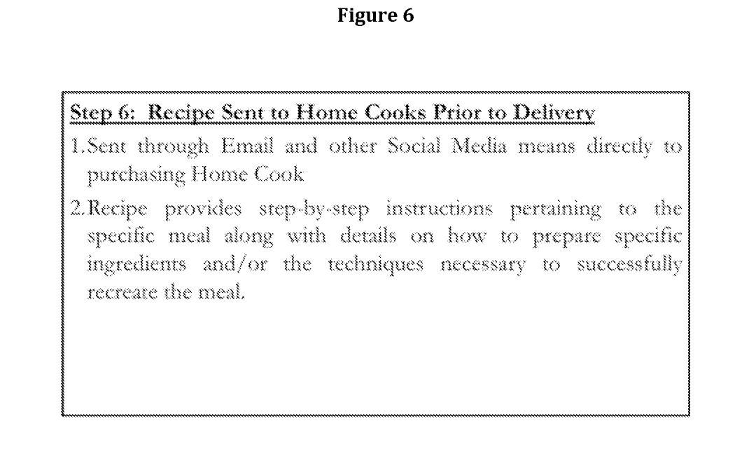

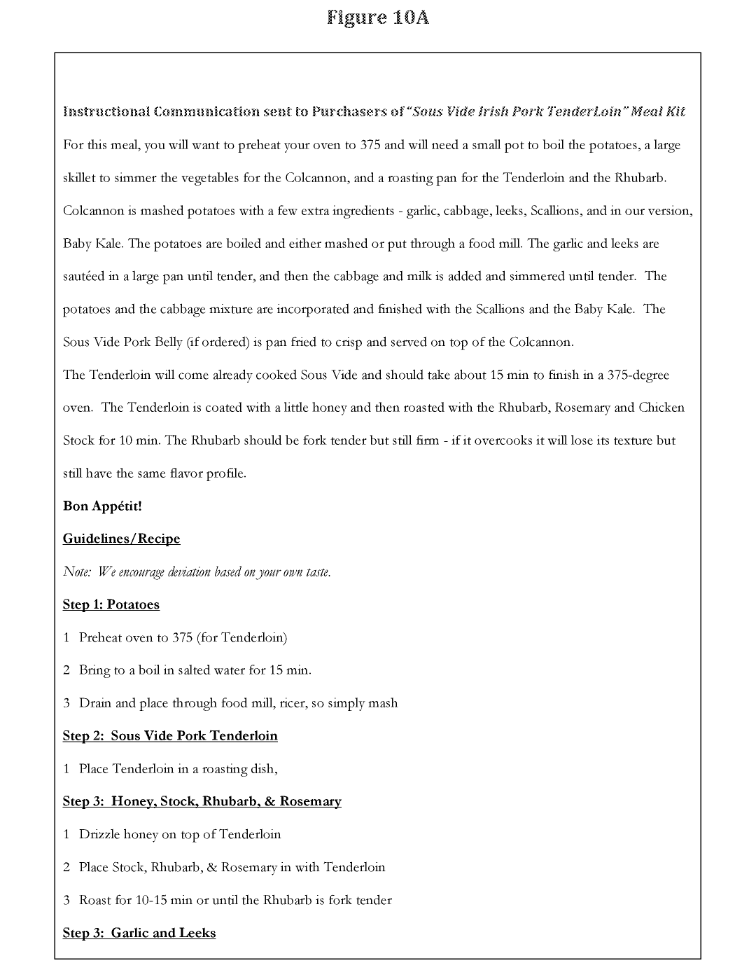

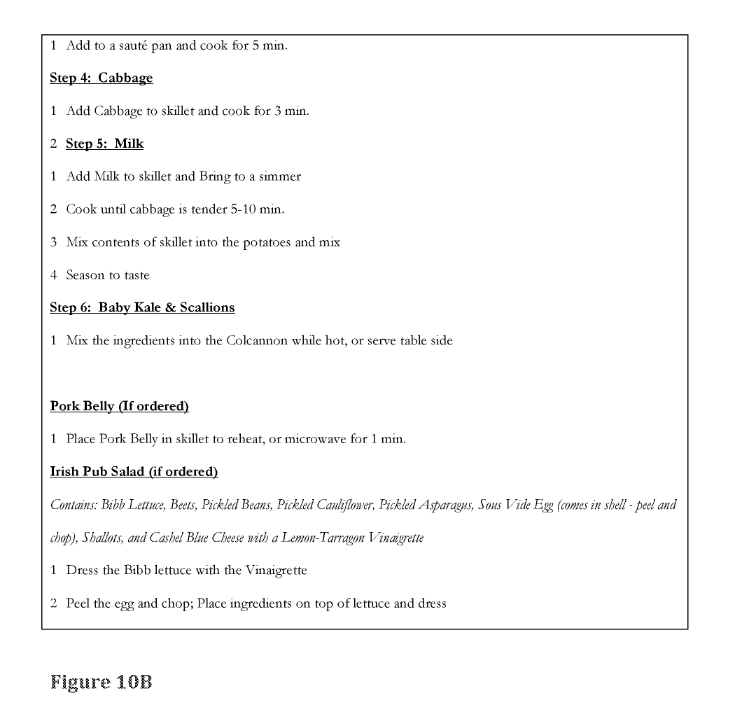

As seen in FIGS. 6 and 10A and 10B, the recipe is sent through email and social media means directly to the purchasing home cook and prior to meal kit delivery. The recipe provides step-by-step instructions pertaining to the specific meal along with details on how to prepare specific ingredients and/or the techniques necessary to successfully recreate the meal at a future date.

### Step 7: Meal Preparation and Delivery

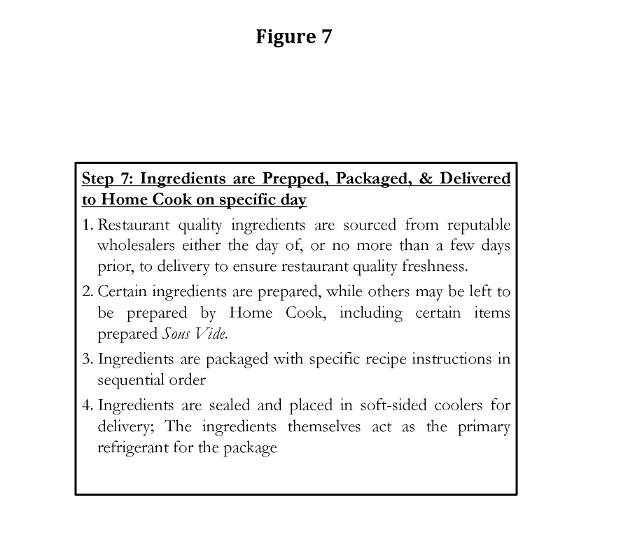

As seen in FIG. 7, the professional chef performs several steps in the preparation stage. Restaurant quality ingredients are sourced from reputable wholesalers either the day of, or no more than a few days prior to, delivery to ensure restaurant-quality freshness. Also, by cooking for several clients, the professional chef achieves an economy of scale by purchasing the ingredients at wholesale prices. As a result, the home cook is provided with a quality of food and a level of freshness not available to them from a local, retail grocery store. The home cook gains access to ingredients typically available only in restaurants. Next, the professional cook prepares the meals in a professional-grade kitchen using cooking methods generally not used by home cooks. The professional chef completes cooking steps that involve complicated processes, consume large amounts of time, and/or require special equipment. For example, the professional chef uses the French technique of sous-vide (under vacuum), a cooking method in which a meat or vegetables is sealed and placed in a liquid bath to cook longer than conventional cooking (up to 47 hours) and at temperatures much lower than those used by a home cook (around 130°-140° F.). It prevents the overcooking of any part of the ingredient, creating tender meat and optimal results. In addition, the vacuum seal prevents evaporation of the rendered juices, creating more flavorful sauces and broths.

The professional chef performs many of the steps that a home chef finds tedious and time-consuming but essential to a delicious meal. The turnips are peeled, sliced and blanched. The meat is marinated. The stocks and sauces are made. The onions and garlic are chopped. Since the professional chef performs these dull and lengthy preparatory functions, the home cook is allowed the joy of actually cooking the meal and exploring new culinary frontiers. The professional chef further increases the flavor profile of the meal by including key flavor components, such as veal stock or cream.

Each serving is individually placed in a separate, sealed, flexible container. The sealing ensures food safety by preventing cross contamination and allows for the packaging of liquids. A label is affixed to each container identifying the container contents as well as providing the specific recipe instructions in sequential order. The ingredient containers are then placed in a soft-sided cooler with an ice pack(s) inserted to keep the items chilled. The ingredients, including any liquid such as stock, milk, or even water (for rice), also are chilled or frozen to act as a refrigerant. In certain cases, the ingredients serve as the primary refrigerant for the meal kit. The meal kit is completed and ready for delivery.

The meal kits are delivered to the home cook's residence by known vehicular delivery methods. The home cook is contacted through either a text or social media communication to track the delivery and for notification of delivery and the delivery time (to ensure food safety). For example, a delivery truck driver can drop off the meal kit at the home cook's house. Meals can also be delivered across broader geographic regions through a mailing service, airline transport, or drone service. The delivery of the refrigerated meal kits complies with all the local, state and Federal food safety laws and regulations.

### Step 8: Home Cook Completes the Meals

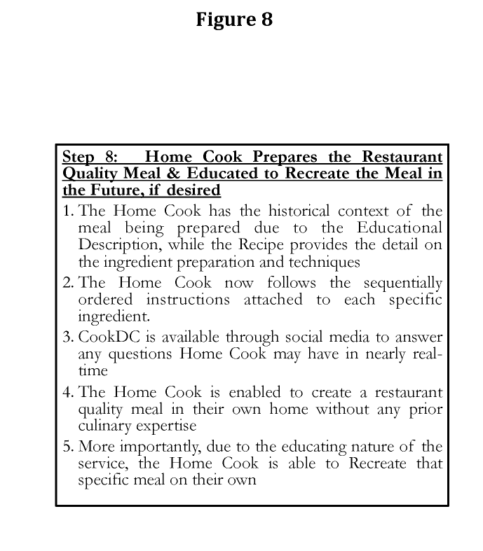

In FIG. 8, bolstered by the historical context of the educational description, provided with the recipe's details of ingredient preparation and techniques, and in receipt of the meal kit, the home cook is now prepared to complete the meal. The home cook follows the sequentially ordered instructions attached to each specific ingredient. Using the assembled kit and instructions, a home cook is able to complete the final steps in 30 minutes or less. If needed, the professional chef is available through social media to instantly answer any questions the home cook may have. The home cook is encouraged to explore their creative side and experiment with different, additional ingredients and cooking methods. While the professional cook provides instructions on how to cook the meal, the home cook is fully encouraged to add ingredients or alter the preparations based on their own experience and tastes. In a shortened time frame, the home cook is able to provide a restaurant-quality meal while educating themselves with new cooking dishes and techniques and without needing to perform the time-consuming tasks of food purchasing and preparation. The home cook is enabled to create a restaurant quality meal in his or her own home without any prior culinary expertise. Due to the instructional nature of this service, the home cook is able to recreate the selected meal on his or her own at a future date.

1. A method of providing a restaurant-quality meal to a consumer while simultaneously educating the consumer in culinary techniques, comprised by the steps of:
a business entity creates a menu;
said menu is disseminated;
a consumer selects a menu-item from said menu;
said menu-item is partially-prepared, partially-assembled, and delivered to said consumer;
instructions are delivered to said consumer regarding said menu item;
said consumer completes final preparation and final assembly of said menu-item.

2. The method of claim 1, wherein said business entity creates a menu using a research-based process comprising inquiry into cultural and global perspectives, gastronomical history, diverse ingredients, and advanced cooking techniques.

3. The method of claim 1, wherein said menu dissemination includes electronic dissemination comprising email, social media, and/or a website.

4. The method of claim 1, wherein said menu dissemination comprises postal distribution.

5. The method of claim 1, wherein said instructions of said menu are delivered electronically by email, text, website, and/or social media.

6. The method of claim 1, wherein said instructions of said menu are delivered non-electronically.

7. The method of claim 1, wherein said menu-item delivery is through ground-based vehicular means.

8. The method of claim 1, wherein said menu-item delivery is through air-based means.

9. A method of providing a restaurant-quality meal to a consumer while simultaneously educating the consumer in culinary techniques, comprised by the steps of:
a business entity creates a menu;
said business entity creates said menu using a research-based process comprising inquiry into cultural and global perspectives, gastronomical history, diverse ingredients, and/or advanced cooking techniques;
said menu is disseminated;
a consumer selects a menu-item from said menu;
said menu-item is partially-prepared, partially-assembled, and delivered to said consumer;
instructions are delivered to said consumer regarding said menu item;
said consumer completes final preparation and final assembly of said menu-item.

10. The method of claim 9, wherein menu dissemination includes electronic dissemination comprising email, social media, and/or a website.

11. The method of claim 9, wherein said menu dissemination comprises postal distribution.

12. The method of claim 9 wherein said instructions of said menu are delivered electronically by email, text, website, and/or social media.

13. The method of claim 9 wherein said instructions of said menu are delivered non-electronically.

14. The method of claim 9 wherein said menu-item is partially-prepared and partially-assembled by a professional chef in a professional kitchen.

15. A method of providing a restaurant-quality meal to a consumer while simultaneously educating the consumer in culinary techniques, comprised by the steps of:
a business entity creates a menu;
said business entity creates said menu using a research-based process comprising inquiry into cultural and global perspectives, gastronomical history, diverse ingredients, and/or advanced cooking techniques;
said menu is disseminated;
a consumer selects a menu-item from said menu;
said menu-item is fully prepared, fully assembled, and delivered to said consumer.
